(19) United States
(12) Patent Application Publication
(10) Pub. No.: US 2013/0018810 A1
(43) Pub. Date: Jan. 17, 2013

(54) SYSTEMS AND METHODS FOR ARRANGING SOCIAL MEETINGS IN CONJUNCTION WITH SPACE/SEAT RESERVATIONS

(71) Applicant: George VonAllmen, Cincinnati, OH (US)

(72) Inventor: George VonAllmen, Cincinnati, OH (US)

(21) Appl. No.: 13/180,641

(22) Filed: Jul. 12, 2011

(51) Int. Cl. G06Q 99/00

(52) U.S. Cl. 705/319

(57) ABSTRACT

Systems and methods for meeting new people outside the scope of a dating service or match making service are disclosed. In particular, the system connects the owners of “space/seat inventory” with their customers in a way that multiple customers with similar interests can interact with each other. As used herein, the phrase “space/seat inventory” means hotel rooms, airline seats, tour bus seats, cruise ship rooms, packaged vacation trips, and the like.

### BACKGROUND OF THE INVENTION

1. Field of the Invention

This invention relates broadly to social networking via the internet. More particularly, this invention relates to systems and methods for arranging social meetings in conjunction with space/seat reservations.

2. State of the Art

One of the fastest growing industries of the twenty-first century is social networking via the internet. Successful services such as Facebook, LinkedIn, Plaxo, Twitter, and others allow people to interact with friends and customers instantaneously via the internet. In addition, these services also permit like minded people to meet through the formation of special interest groups and the publication of user profiles. Sometimes, members of a group who have never before met face to face will organize an outing where members of the group can meet face to face. For the most part, face to face meetings are arranged “manually”. That is, although the internet is used to send invitations, they are manually sent to specific users or to the members of a specific group.

U.S. Pat. No. 7,761,386 to Teicher describes a “Method and Apparatus for Arranging Social Meetings”. Individuals, couples, and families subscribe to a computerized service for facilitating the arrangement of their outings and social meetings. Subscribers fill in wish-lists to specify their level of interest in specific attractions, in getting together with specific other subscribers, and in arranging their preferred schedules for outings. An encounter generator processes the subscriber wish-lists to identify matches of subscribers who are interested in the same attraction, who favor each other's company, and who are free at the same time. The system notifies the matched subscribers, optionally offering ticketing and/or reservation assistance. Partial matches are optionally referred to the respective subscribers for negotiating the unmatched schedule or attraction. The system is adaptable to serve singles who wish to identify and get to know a prospective mate through mutual visits to attractions, as well as individuals, couples, and families who want to go out with their existing friends or make new friends.

### SUMMARY OF THE INVENTION

The present invention provides systems and methods for meeting new people outside the scope of a dating service or match making service. In particular, the system connects the owners of “space/seat inventory” with their customers in a way that multiple customers with similar interests can interact with each other. As used herein, the phrase “space/seat inventory” means hotel rooms, airline seats, tour bus seats, cruise ship rooms, packaged vacation trips, and the like.

Both the owners of the “space/seat inventory” and their customers (or potential customers) are considered users of the system of the present invention. A customer (buyer of “space/seat inventory”) creates a profile that indicates the customer's interests, group membership, hobbies, and/or similar information. When a customer makes a reservation for a “space/seat”, the system of the present invention compares the customer's profile to other customers who will be in the vicinity of the reserved “space/seat” at the same time as the customer. The customer is then notified whether (and how many) other people (customers) with the same (or similar) interests, group membership, hobbies, etc. will be in the vicinity (e.g. staying at the same hotel, taking the same cruise, etc.) when the customer is going to be there. Up until this point, all customer information is anonymous. Thus customers will know how many other customers will be there and what the common link(s) are among the customers.

According to the invention, the customer has the option of blindly introducing him/herself to the other customers via email without knowing the identity of the email recipients. The email recipients then have the opportunity to break their anonymity and introduce themselves to the customer via a non-anonymous email.

An example of the methods of the invention in use involves the booking of hotel space at the Indianapolis 500. A customer indicates that he is a fan of the driver Danica Patrick. The system according to the invention can tell the customer whether, and how many, Danica Patrick fans will be staying at the same hotel.

Another example of the invention in use is where a customer interested in civil war history can determine whether, and how many, other people interested in civil war history will be on the same cruise that the customer is booking.

Still another example of the invention is where a customer is taking a business trip and wants to add some entertainment to the trip by meeting people with similar interests.

The systems according to the invention include at least one customer interface where a customer can choose to have profile information anonymously associated with him/her in the system database. According to the presently preferred embodiment, several interfaces are provided in the form of social networking applications within the scope of existing internet social networking platforms, e.g. a Facebook application, a LinkedIn application, etc. When a customer chooses one of these applications, they can choose to have their profile information automatically imported into the database of the invention. The customer interface also preferably provides links to owners participating in the service. Moreover, the customer interface may be accessed via owner reservation systems. According to one aspect of the invention, the interface of owner reservation systems is modified to provide the customer interface of the invention.

The database is preferably accessed via a plurality of “business functions” which include the store and retrieve function for storing and retrieving customer information, customer registration function, customer login/logout function, and a customer information administration function. In addition, a “trips” search and match function is provided for matching the customer's reservation with reservations of other customers having matching profile features. The trips search and match function preferably operates in more than one mode. In one mode, the search and match is performed when a customer is making a reservation. In another mode, the search and match is performed before the customer makes a reservation. For example, before reserving hotel space at the Indy 500, the customer may invoke the search and match function to determine which hotel is most popular among Danica Patrick fans. The “business functions” also include batch processes feeds from social networks such as Facebook and to process feeds from owners regarding inventory.

The business functions are accessed via the internet through “channels”. These channels include access through owner reservation systems, direct access to the system of the invention, access via a service center for customer support, as well as batch access from social networks and owner reservation systems.

Additional objects and advantages of the invention will become apparent to those skilled in the art upon reference to the detailed description taken in conjunction with the provided figures.

### BRIEF DESCRIPTION OF THE DRAWINGS

FIGS. 1 through 5 illustrate aspects of the systems of the invention in a schematic way; and

FIGS. 6 through 9 are flow charts illustrating the methods of the invention.

### DETAILED DESCRIPTION

The systems and methods of the invention are described and illustrated herein using the trademark NEAT WAY TO MEET™.

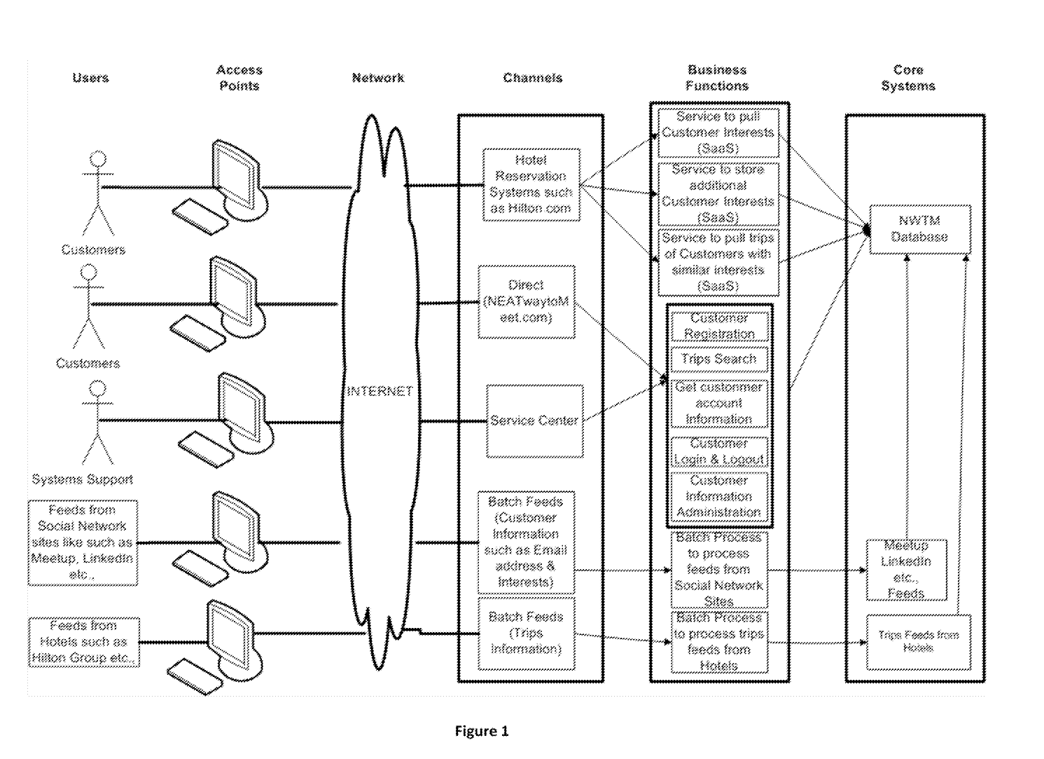

FIG. 1 illustrates the business conceptual architecture of the systems according to the invention. The Business Conceptual Architecture is a high-level representation of the solution focused on defining the architectural layers and the functions provided by those layers. This provides a pictorial representation of the solution to the business and technology stakeholders, which helps support communication of the conceptual architecture to the targeted audience. This also provides a simple overview of the basic building blocks of the system, which are represented as inter-relating tiers or layers. The conceptual architecture is as unconstrained as possible and addresses the business needs without assuming technology details unless explicitly required or mandated.

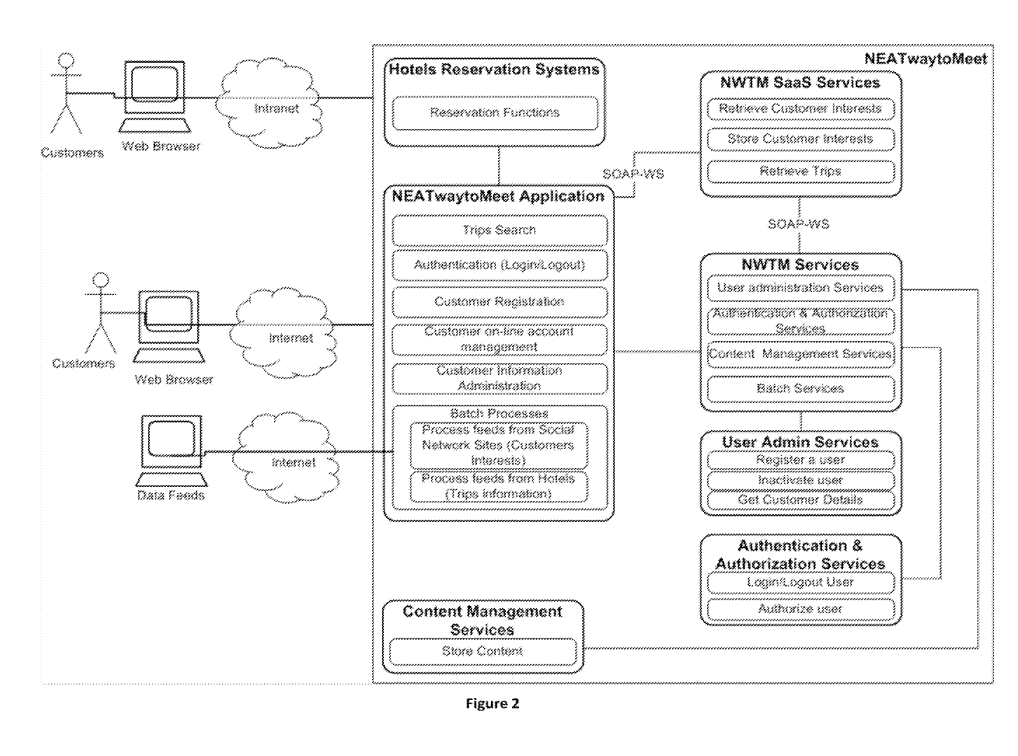

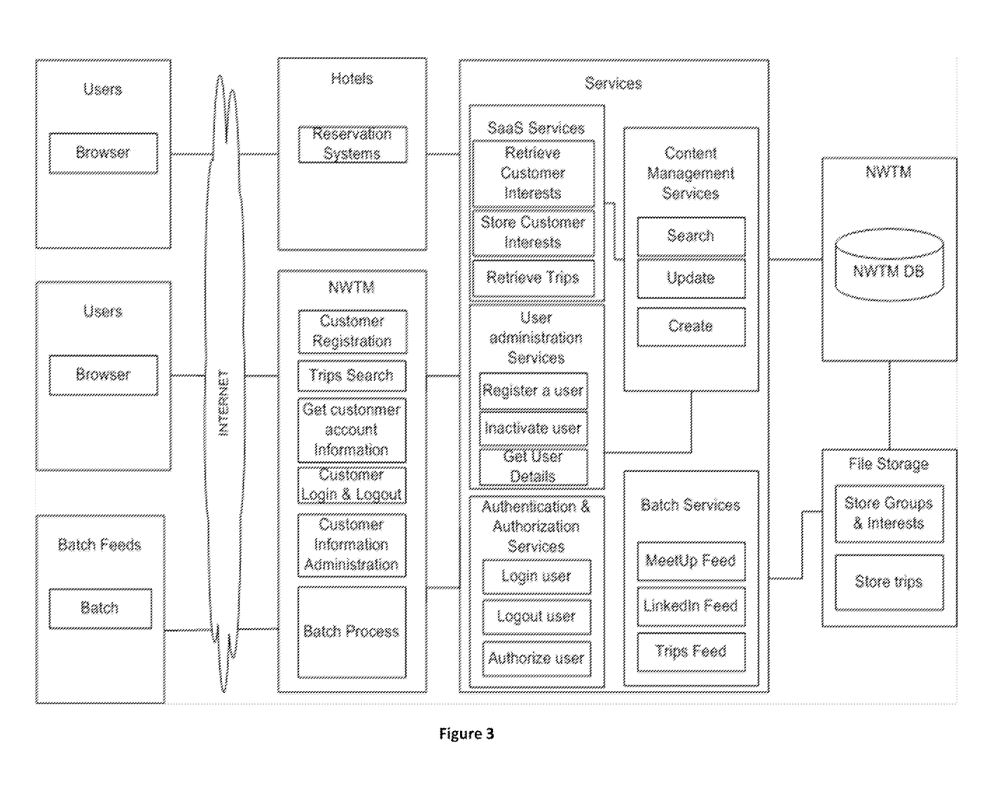

FIGS. 2 and 3 illustrate the architecture subsystems. The Architecture Subsystem provides more details about the entities that compose the solution. As more decisions are made with respect to the design of the solution, some constraints become evident within the architecture subsystem diagram. There are two subsystem diagrams, one is high level and the other provides more details.

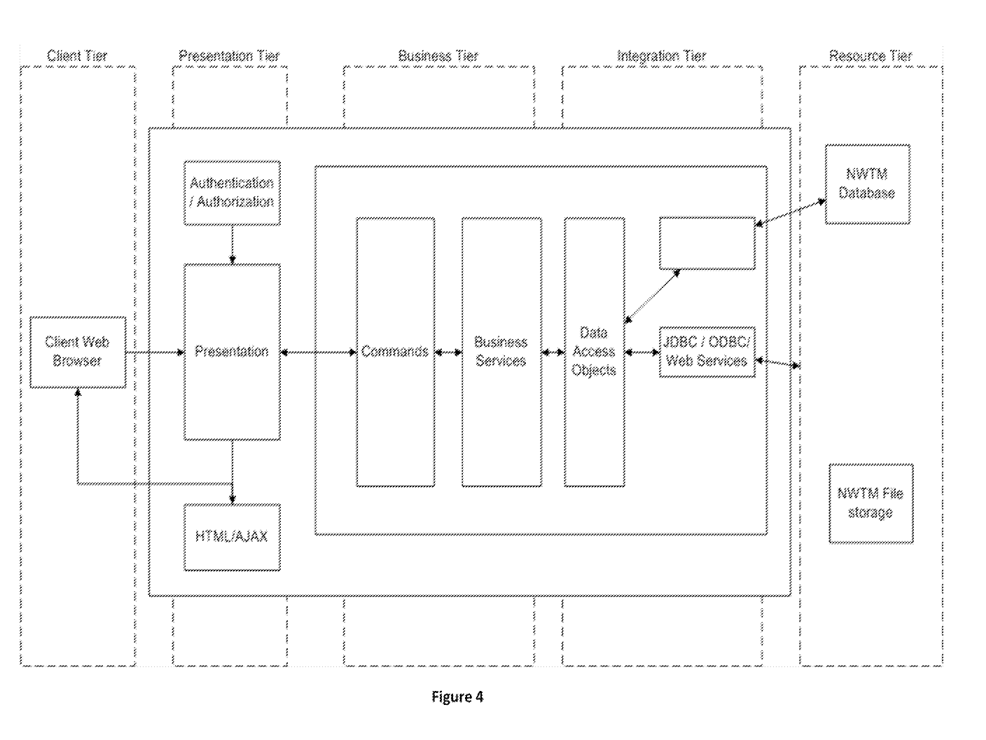

FIG. 4 illustrates the conceptual component model. The Conceptual Component Model provides a high-level representation of the major conceptual components of the solution. A conceptual component is an entity that represents a portion of the technical solution, provides a set of related services and implements those services through well-defined interfaces. Conceptual components are technology-agnostic and typically represent systems, servers, repositories, service providers and other high-level entities. A Conceptual Component Model is made up of a static view provided in the Conceptual Component Diagrams.

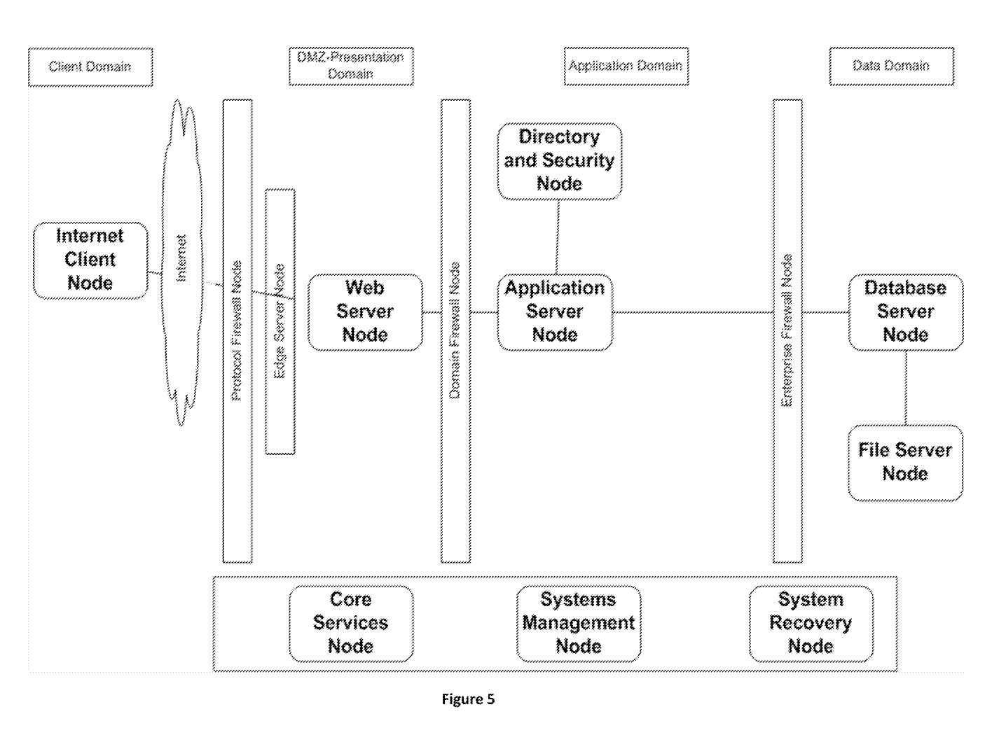

FIG. 5 illustrates the logical operations model. The Operational Model communicates the architecture of the solution to the supporting infrastructure teams to ensure that all non-functional requirements and operational aspects of the system are addressed. This provides a design that clearly defines and articulates the operational aspects of the working system through logical and physical views of the solution. The logical view provides a general picture of the major pieces required for the system and enables the analysis and design activities to proceed without requiring specific details on the physical aspects of the system. The Operational Model also provides details on the system monitoring requirements, approach and tools used for each layer or transaction type to ensure the environment remains operational for the users. This outlines the main operational pieces of the system at a logical level, showing the flow of information through the solution and providing a clear understanding of the nodes involved in handling requests. The logical nodes shown within the design may be mapped to one or more physical nodes, or alternatively, multiple logical nodes may be mapped to a single physical node. Nodes are potential hardware systems, though several logical nodes may be combined onto one physical system.

As seen best in FIG. 1, the system of the invention includes users connected to access points connected via the internet to channels, business functions and core systems. As seen best in FIGS. 2 and 3, hotel reservation systems interact with the systems of the invention. Although the figures refer to hotel reservation systems, the system of the invention can interact with any reservation system as described above.

As shown in FIG. 4, the components of the system of the invention include the client tier, the presentation tier, the business tier, the integration tier and the resource tier. FIG. 5 illustrates a series of firewalls that protect different aspects of the system.

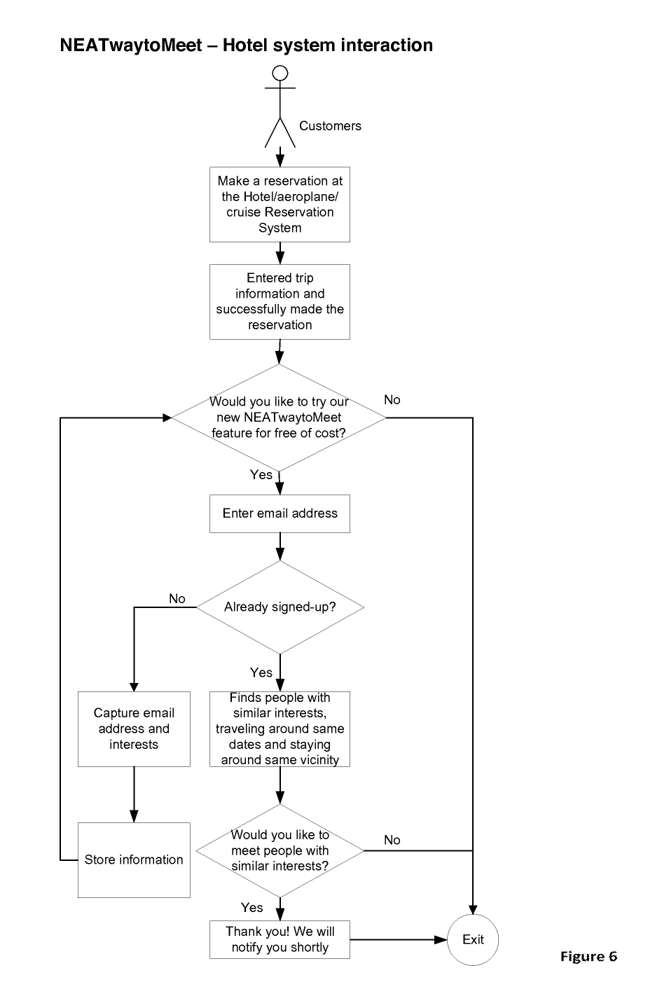

FIG. 6 illustrates one method according to the invention from the purchaser's point of view. According to this embodiment, a customer makes a reservation through a supplier's reservation system on the web. The customer enters the trip information and successfully makes the reservation at which point, the customer is prompted by the system whether they want to use the free NEAT WAY TO MEET™ feature to see if people with similar interests/memberships/etc. will be in the same place at the same time. If the customer chooses they log into the system using their email address. If they are not already registered with the system, they are prompted to enter information about themselves which is then stored.

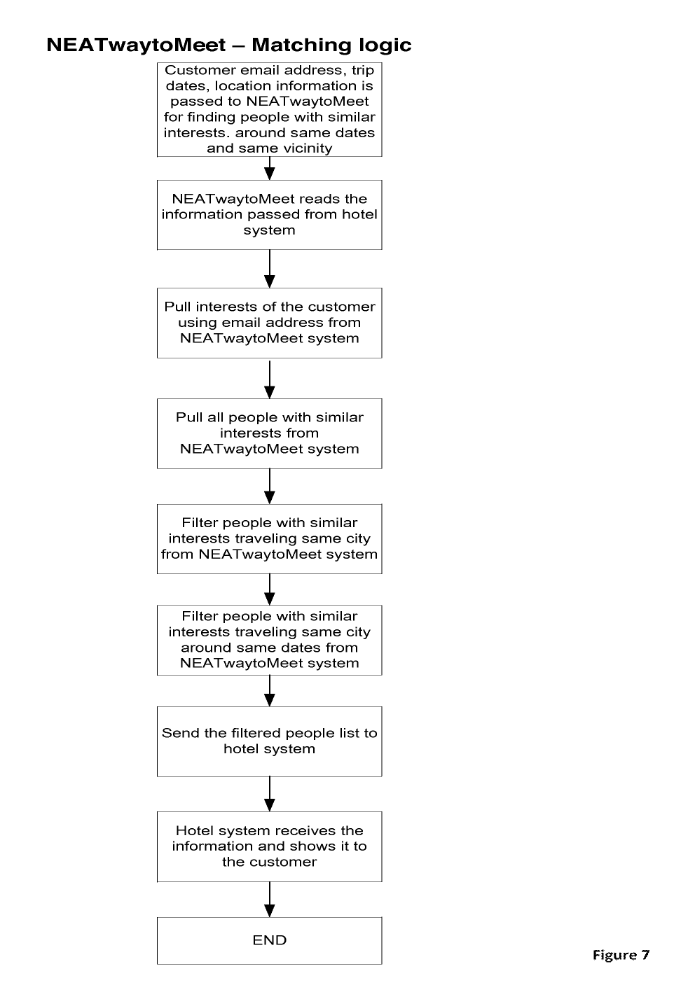

Once a customer is registered with the system, the system will then search its database for other customers with similar interests/memberships/etc. who will be at the same place at the same time. The customer is then prompted to decide if they want to meet the found matches. The matchmaking logic is illustrated in FIG. 7.

Turning now to FIG. 7, the customer ID and personal information are fed to the system and the reservation information is also read. The customer interests/memberships/etc. are searched in the system database and other customers with matching/similar interests/memberships/etc. and matching reservations are found. The list of matching people is sent to the reservation system. The reservation system displays the information about the matches but not their identity. The customer is then enabled to send a blind email to the matches revealing the customer's identity (email address) and asking the (unknown) recipients if they would like to meet the customer. If any of the matches do, they communicate by email with the customer.

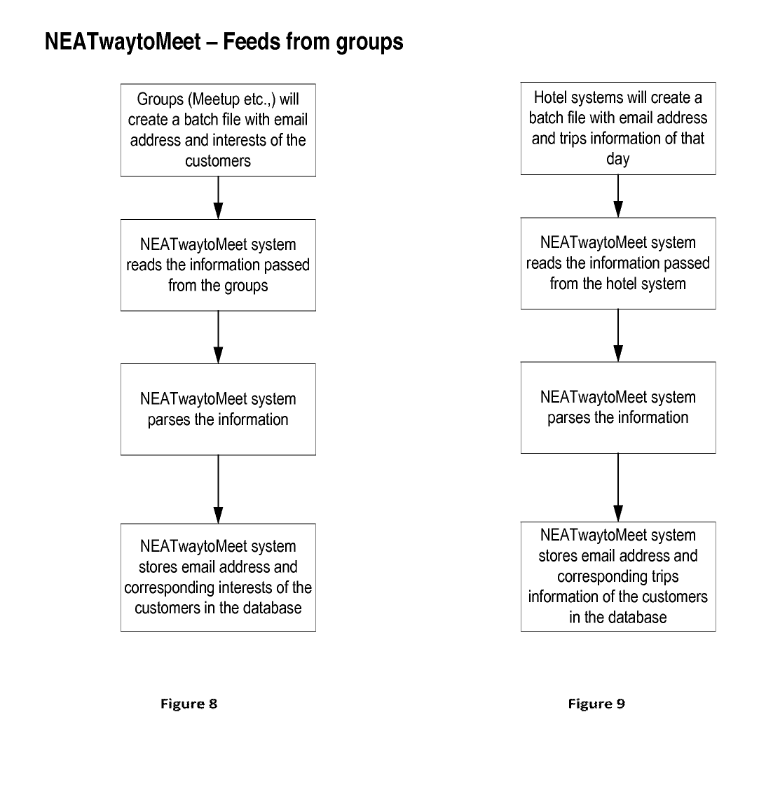

FIGS. 8 and 9 illustrate how information is collected in batch files by the system from groups and hotels to update the system database(s). As used herein “groups” means social networking websites such as Facebook, Meetup, LinkedIn, etc. where a membership application resides so that customers can join the system before making a reservation. Using these applications, the customer can also find reservation opportunities before making a reservation. For example, if the customer wants to take a vacation between August 1 and 7, the user can find which travel destination will have, at that time, the most people having similar interests/memberships/etc.

Other applications for the invention include sporting events, special events, concerts, restaurant seats, rental property, bus and train tickets, tours and excursions.

There have been described and illustrated herein several embodiments of systems and methods for arranging social meetings in conjunction with space/seat reservations. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A method of socially networking consumers with like interests, said method being implemented via a plurality of computing devices coupled to a telecommunications network, said method comprising:
collecting profile data from consumers regarding their interests, hobbies or memberships; and
anonymously matching consumers when purchasing or shopping to purchase time sensitive goods or services.

2. The method according to claim 1, wherein:
the time sensitive goods or services include hotel rooms.

3. The method according to claim 1, wherein:
the time sensitive goods or services include space on a ship.

4. The method according to claim 1, wherein:
the time sensitive goods or services include space on a tour.

5. The method according to claim 1, further comprising:
providing consumers with the ability to blind email requests to meet to matching anonymous consumers.

6. A system of socially networking consumers with like interests, said system being implemented via a plurality of computing devices coupled to a telecommunications network, said system comprising:
means for collecting profile data from consumers regarding their interests, hobbies or memberships; and
means for anonymously matching consumers when purchasing or shopping to purchase time sensitive goods or services.

7. The system according to claim 6, wherein:
the time sensitive goods or services include hotel rooms.

8. The system according to claim 6, wherein:
the time sensitive goods or services include space on a ship.

9. The system according to claim 6, wherein:
the time sensitive goods or services include space on a tour.

10. The system according to claim 6, further comprising:
means for providing consumers with the ability to blind email requests to meet to matching anonymous consumers.
